(19) United States
(12) Patent Application Publication
(10) Pub. No.: US 2023/0147967 A1
(43) Pub. Date: May 11, 2023

(54) R-T-B BASED PERMANENT MAGNET

(71) Applicant: TDK Corporation, Tokyo (JP)

(72) Inventors: Lihua LIU, Tokyo (JP); Kenichi SUZUKI, Tokyo (JP)

(73) Assignee: TDK Corporation, Tokyo (JP)

(21) Appl. No.: 17/980,804

(22) Filed: Nov. 4, 2022

(30) Foreign Application Priority Data
Nov. 9, 2021 (JP) 2021-182539
Sep. 5, 2022 (JP) 2022-140798

(51) Int. Cl. H01F 1/057; H01F 41/02; C22C 38/00

(52) U.S. Cl. CPC H01F 1/0577; H01F 41/0293; C22C 38/005; C22C 2202/02

(57) ABSTRACT

An R-T-B based permanent magnet includes a rare-earth element R, a transition metal element T, and B. The R-T-B based permanent magnet includes at least Nd as R. The R-T-B based permanent magnet includes at least Fe as T. The R-T-B based permanent magnet contains a plurality of main phase grains and a plurality of voids. The plurality of main phase grains includes at least R, T, and B. An area ratio of the plurality of voids in an arbitrary cross-section of the R-T-B based permanent magnet is larger than 0.2% and 2% or smaller.

### TECHNICAL FIELD

The present disclosure relates to an R-T-B based permanent magnet.

### BACKGROUND

The R-T-B based permanent magnet includes a rare-earth element R (Nd or the like), a transition metal element T (Fe or the like), and boron (B). The R-T-B based permanent magnet is excellent in magnetic characteristics and has been widely used. As the R-T-B based permanent magnet, a sintered magnet produced by a powder metallurgy method, and a hot deformed magnet produced by a hot plastic deformation method are known. An alloy ribbon that is a raw material of the hot deformed magnet is obtained by a rapid-solidification method. In the rapid-solidification method, a molten metal of an R-T-B based alloy is rapidly cooled down on a surface of a cooled roll. As a result, the molten metal solidifies, and alloy ribbons are formed. The alloy ribbons obtained by the rapid-solidification method contain fine crystals of the alloy (and an amorphous alloy). Accordingly, crystal grains (main phase grains) constituting the hot deformed magnet are finer in comparison to the sintered magnet. As expressed by Kronmuller's equation, it is known that the finer a crystal grain size of the R-T-B based permanent magnet is, the further coercivity (HcJ) increases. Accordingly, the hot deformed magnet should have higher coercivity in comparison to the sintered magnet with the same composition. However, the coercivity of the hot deformed magnet in the related art is equivalent to the coercivity of the sintered magnet having the same composition, and high coercivity expected from the fine crystal grain size is not obtained.

A main factor of the decrease in the coercivity of the R-T-B based permanent magnet is a reverse magnetic domain generated in the R-T-B based permanent magnet. In accordance with application of a reverse magnetic field to the R-T-B based permanent magnet, the reverse magnetic domain becomes a nucleus of magnetization reversal, and a magnetic domain wall propagates to the entirety of the R-T-B based permanent magnet from the reverse magnetic domain. In accordance with propagation of the magnetic domain wall, magnetization of each main phase grain in the R-T-B based permanent magnet is reversed. The magnetization reversal of each of the main phase grains is suppressed by pinning of the magnetic domain wall at a pinning site such as a grain boundary (refer to Non-Patent Literatures 1 to 3).
Non-Patent Literature 1: M. Soderznik et al, Magnetization reversal process of anisotropic hot-deformed magnets observed by magneto-optical Kerr effect microscopy, Journal of Alloys and Compounds 771 (2019), 51 to 59.
Non-Patent Literature 2: J. Li et al, Angular dependence and thermal stability of coercivity of Nd-rich Ga doped Nd—Fe—B sintered magnet, Acta Materialia 187 (2020), 66 to 72.
Non-Patent Literature 3: D. I. PAUL, APPLICATION OF SOLITON THEORY TO FERROMAGNETIC DOMAIN WALL PINNING, PHYSICS LETTERS, 23 Jan. 1978, Volume 64A, number 5.

### SUMMARY

The larger a difference in an intensity of an anisotropic magnetic field between a pinning site and a main phase grain is, the more a movement of a magnetic domain wall is likely to be suppressed due to pinning of the magnetic domain wall. However, a grain boundary phase in a hot deformed magnet in the related art does not sufficiently function as a pinning site. For example, the hot deformed magnet in the related art contains an R-rich phase, in which a concentration of a rare-earth element R (Nd or the like) is higher in comparison to a main phase grain, as a grain boundary phase (sub-phase). A composition of the R-rich phase is close to Nd₃₀Fe₇₀, and the R-rich phase is a ferromagnetic substance and is also a soft magnetic substance. Accordingly, a difference in the intensity of the anisotropic magnetic field between the R-rich phase and the main phase grain is small, and the R-rich phase does not sufficiently function as the pinning site.

The present inventors found that a coercivity of the hot deformed magnet increases by intentionally forming a plurality of voids as the pinning site in the hot deformed magnet. An intensity of the anisotropic magnetic field in the voids is substantially zero, a difference in the intensity of the anisotropic magnetic field between the voids and the main phase grain is large, and the movement of a magnetic domain wall is effectively suppressed due to pinning of a magnetic domain wall at the voids. However, a ratio of volumes of the main phase grains (a volume ratio of the main phases) in the hot deformed magnet decreases in accordance with an increase of the voids in the hot deformed magnet, and a residual magnetic flux density of the hot deformed magnet decreases. Accordingly, it is required to suppress a decrease in the residual magnetic flux density in accordance with formation of the voids, and to increase the coercivity by the voids.

An object of an aspect of the present invention is to provide an R-T-B based permanent magnet having a high coercivity and a high residual magnetic flux density.

For example, the aspect of the present invention relates to the following R-T-B based permanent magnet.

[1] An R-T-B based permanent magnet including a rare-earth element R, a transition metal element T, and B, wherein the R-T-B based permanent magnet includes at least Nd as the R, the R-T-B based permanent magnet includes at least Fe as the T, the R-T-B based permanent magnet contains a plurality of main phase grains and a plurality of voids, the plurality of main phase grains includes at least the R, the T, and B, an area ratio of the plurality of voids in an arbitrary cross-section of the R-T-B based permanent magnet is larger than 0.2% and 2% or smaller.

[2] The R-T-B based permanent magnet according to [1], wherein an average value of an area of each of the plurality of voids in the arbitrary cross-section of the R-T-B based permanent magnet is from 0.1 (μm)² to 7 (μm)².

[3] The R-T-B based permanent magnet according to [1] or [2], wherein a standard deviation of an area of each of the plurality of voids in the arbitrary cross-section of the R-T-B based permanent magnet is from 0 (μm)² to 5 (μm)².

[4] The R-T-B based permanent magnet according to any one of [1] to [3], wherein the arbitrary cross-section of the R-T-B based permanent magnet has a rectangular shape, one side among four sides of the rectangular shape is an x-axis, one side orthogonal to the x-axis among the four sides of the rectangular shape is a y-axis, an intersection of the x-axis and the y-axis is the origin, in a coordinate system composed of the origin, the x-axis, and the y-axis, a position of a geometric center of each of the plurality of voids is expressed as (x,y), and an absolute value of a correlation coefficient r of x and y, which is calculated from the position of the geometric center of each of the plurality of voids, is from 0 to 0.2.

[5] The R-T-B based permanent magnet according to any one of [1] to [4], wherein in a cross-section of the R-T-B based permanent magnet which is approximately parallel to an easy magnetization axis direction of the R-T-B based permanent magnet, the plurality of main phase grains are flat, and in the cross-section of the R-T-B based permanent magnet which is approximately parallel to the easy magnetization axis direction of the R-T-B based permanent magnet, an average value of a length of a short axis of the plurality of main phase grains is from 20 nm to 200 nm.

[6] The R-T-B based permanent magnet according to any one of [1] to [5], wherein a content of the R in the R-T-B based permanent magnet is from 28 mass % to 33 mass %, and a content of B in the R-T-B based permanent magnet is from 0.75 mass % to 1.20 mass %.

[7] The R-T-B based permanent magnet according to any one of [1] to [6], wherein the plurality of main phase grains are stacked along an easy magnetization axis direction of the R-T-B based permanent magnet.

[8] The R-T-B based permanent magnet according to any one of [1] to [7], wherein the R-T-B based permanent magnet is a hot deformed magnet.

[9] The R-T-B based permanent magnet according to any one of [1] to [8], further containing a plurality of R-rich phases, wherein a concentration of the R in the plurality of R-rich phases is higher than a concentration of the R in the plurality of main phase grains, and a unit of the concentration of the R is atomic %.

[10] The R-T-B based permanent magnet according to any one of [1] to [9], wherein a long-axis-direction length of each of the plurality of voids observed in the arbitrary cross-section of the R-T-B based permanent magnet is expressed by L_{L}, a short-axis-direction length of each of the plurality of voids observed in the arbitrary cross-section of the R-T-B based permanent magnet is expressed by L_{S}, an aspect ratio of each of the plurality of voids observed in the arbitrary cross-section of the R-T-B based permanent magnet is expressed by L_{L}/L_{S}, and an average value of L_{L}/L_{S} is from 1 to 2.

According to the present invention, an R-T-B based permanent magnet having a high coercivity and a high residual magnetic flux density is provided.

### BRIEF DESCRIPTION OF THE DRAWINGS

FIG. 1A is a schematic perspective view of an R-T-B based permanent magnet 2 according to an embodiment of the present invention, and FIG. 1B is a schematic view of a cross-section 2cs of the R-T-B based permanent magnet 2 (an arrow view in a b-b line direction in the R-T-B based permanent magnet 2).

FIG. 2 is an enlarged view of a part (region II) of the cross-section 2cs illustrated in FIG. 1B.

FIG. 3 is a perspective view of a cavity formed in a mold used for a method of producing an R-T-B based permanent magnet according to the embodiment of the present invention.

FIG. 4A and FIG. 4B are images related to a cross-section of Example 4 of the present invention.

FIG. 5A and FIG. 5B are images related to the cross-section of Example 4 of the present invention.

FIG. 6 is an image related to the cross-section of Example 4 of the present invention.

FIG. 7A and FIG. 7B are images related to a cross-section of Comparative Example 2.

FIG. 8A and FIG. 8B are images related to the cross-section of Comparative Example 2.

### DETAILED DESCRIPTION

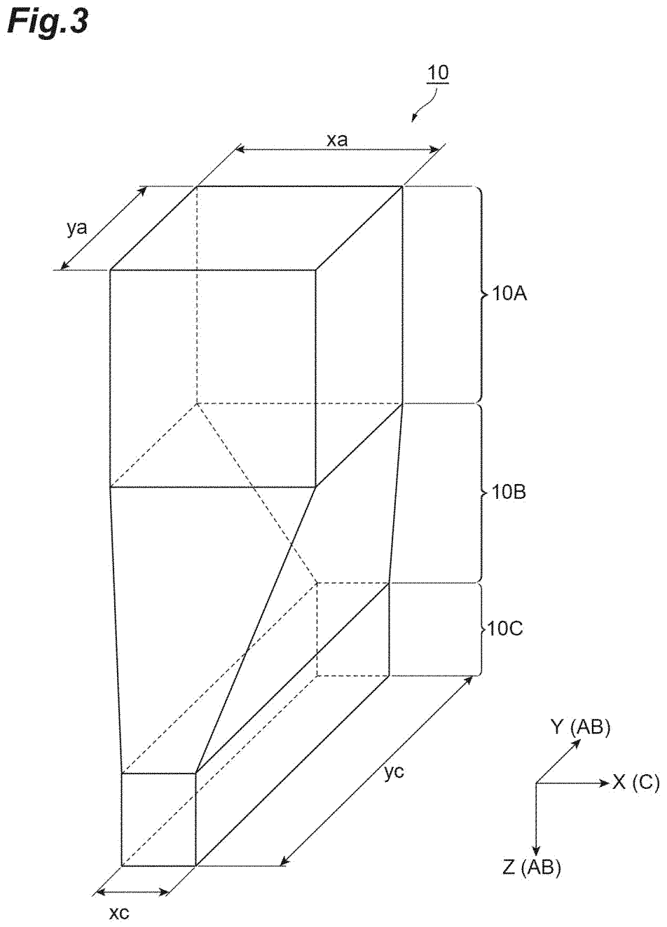

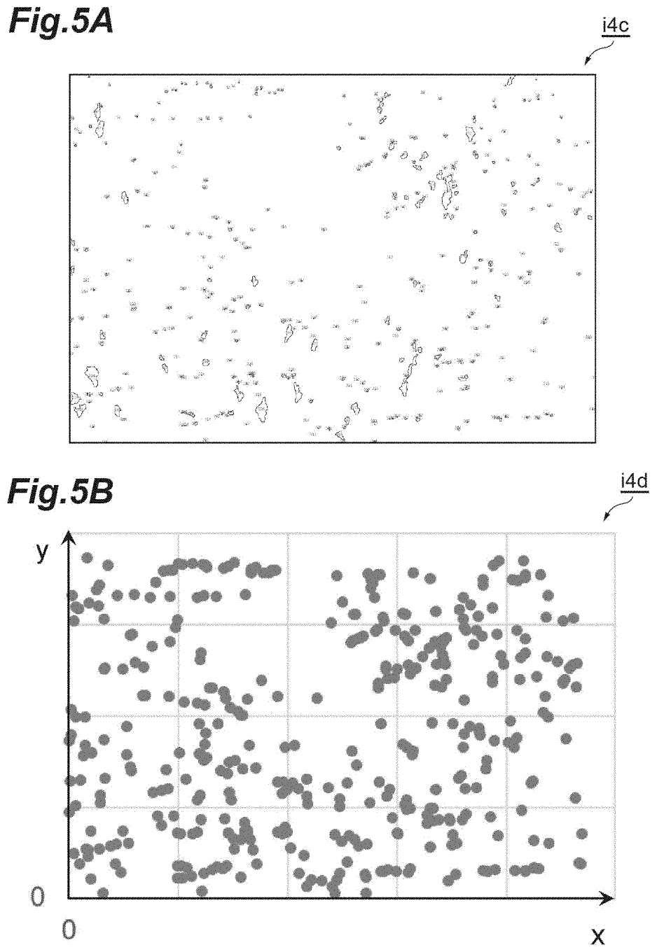

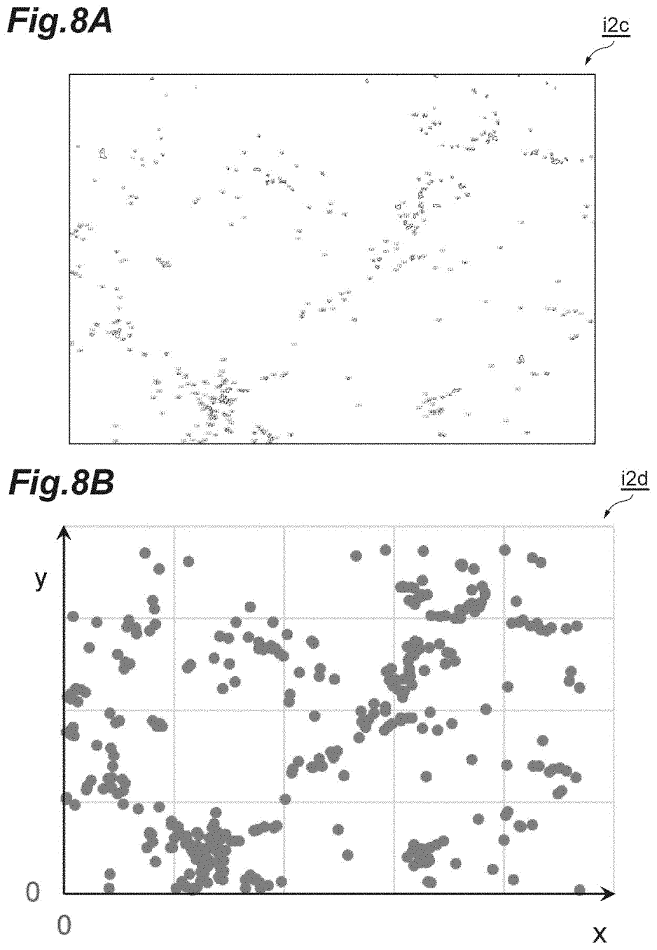

Hereinafter, an appropriate embodiment of the present invention will be described with reference to the accompanying drawings. In the drawings, the same reference numeral will be given to the equivalent constituent elements. The present invention is not limited to the following embodiment. “Permanent magnet” in the following description represents an R-T-B based permanent magnet. A unit of a concentration of each element in the permanent magnet in the following description is atomic %. X, Y, and Z in FIG. 3 represent three coordinate axes orthogonal to each other. Coordinate axes in FIG. 3 have no relation to coordinate axes (an x-axis and a y-axis) in FIG. 5B and coordinate axes (an x-axis and a y-axis) in FIG. 8B.

(Permanent Magnet)

The permanent magnet according to this embodiment includes at least a rare-earth element (R), a transition metal element (T), and boron (B). The permanent magnet according to this embodiment is a hot deformed magnet. However, the permanent magnet according to the present invention may be a sintered magnet.

The permanent magnet includes at least neodymium as the rare-earth element R. The permanent magnet may include another rare-earth element R in addition to Nd. The other rare-earth element R included in the permanent magnet may be at least one kind selected from the group consisting of scandium (Sc), yttrium (Y), lanthanum (La), cerium (Ce), praseodymium (Pr), samarium (Sm), europium (Eu), gadolinium (Gd), terbium (Tb), dysprosium (Dy), Holmium (Ho), Erbium (Er), Thulium (Tin), Ytterbium (Yb), and Lutetium (Lu). The permanent magnet 2 does not have to include heavy rare-earth elements (for example, both Dy and Tb).

The permanent magnet includes at least iron (Fe) as the transition metal element T. The permanent magnet may include only Fe as the transition metal element T. The permanent magnet may include both Fe and cobalt (Co) as the transition metal element T.

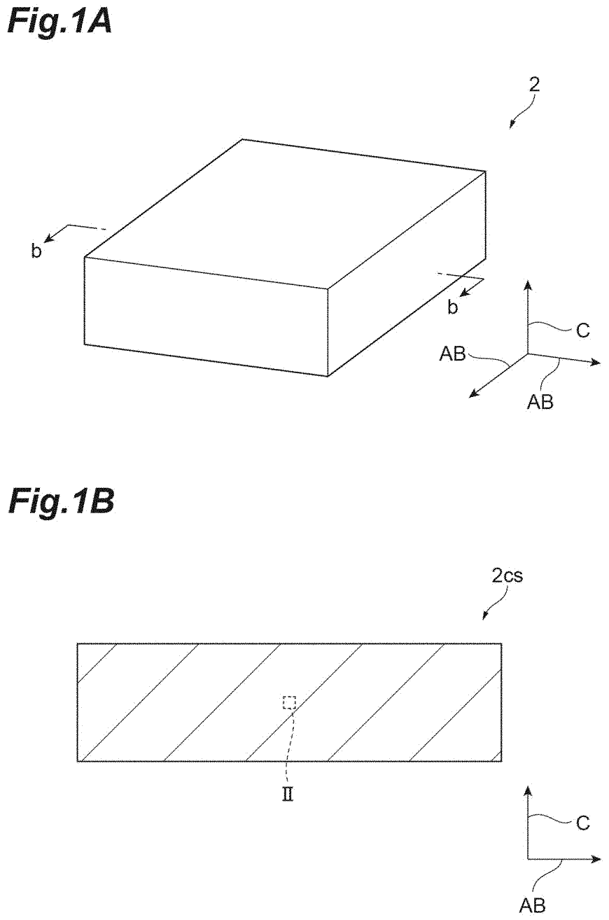

FIG. 1A is a perspective view of the permanent magnet 2 according to this embodiment, and FIG. 1B is a schematic view of a cross-section 2cs of the permanent magnet 2. The cross-section 2cs of the permanent magnet 2 is approximately parallel to an easy magnetization axis direction C of the permanent magnet 2. The easy magnetization axis direction C is a direction parallel to a straight line connecting a pair of magnetic poles of the permanent magnet 2. That is, the easy magnetization axis direction C is a direction oriented from an S-pole of the permanent magnet 2 to an N-pole of the permanent magnet 2. The easy magnetization axis direction C may be specified on the basis of measurement of a magnetic flux distribution of the permanent magnet 2. The easy magnetization axis direction C may be specified on the basis of measurement of a magnetic flux distribution of an analysis sample separated from the permanent magnet 2. A direction that is approximately orthogonal to the easy magnetization axis direction C is noted as “AB direction”.

The permanent magnet 2 according to this embodiment is a rectangular parallelepiped (plate). However, a shape of the permanent magnet 2 is not limited to the rectangular parallelepiped. For example, the shape of the permanent magnet 2 may be a cube, a polygonal column, an arc segment, an annular sector, a sphere, a disk, a circular column, a tube, or a ring. A shape of the cross-section 2cs of the permanent magnet 2 may be, for example, a polygon, a circular arc (circular chord), a bow shape, an arch shape, a C-shape, or a circle.

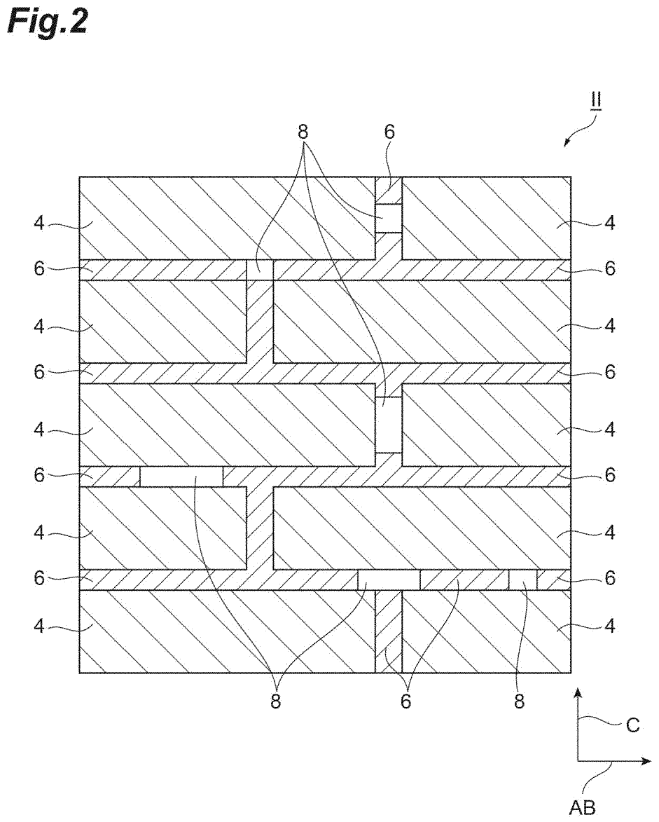

FIG. 2 is an enlarged view of a part (region II) of the cross-section 2cs illustrated in FIG. 1B. As illustrated in FIG. 2, the permanent magnet 2 contains a plurality of main phase grains 4. The permanent magnet 2 may further contain a plurality of R-rich phases 6 as a sub-phase. Each of the R-rich phases 6 is located between the plurality of main phase grains 4. The R-rich phase 6 may be one kind of a grain boundary phase contained in a grain boundary of the plurality of main phase grains 4. The grain boundary containing the R-rich phase 6 may be a grain boundary multiple junction surrounded by three or more pieces of the main phase grains 4. The grain boundary containing the R-rich phase 6 may be a two-grain boundary between two pieces of the main phase grains 4.

As illustrated in FIG. 2, a plurality of voids 8 are formed in the permanent magnet 2. The plurality of voids 8 may also be referred to as a plurality of pores. At least a part of the plurality of voids 8 may be formed in the grain boundary multiple junction. At least a part of the plurality of voids 8 may be formed in the two-grain boundary.

An area ratio (pr) of the plurality of voids 8 in an arbitrary cross-section of the permanent magnet 2 is larger than 0.2% and 2% or smaller. The area ratio (pr) of the plurality of voids 8 in an arbitrary cross-section of the permanent magnet 2 may be expressed as Av/Acs (unit: %). Av represents a sum of an area (opening area) of each of the plurality of voids 8 measured in an arbitrary cross-section of the permanent magnet 2. Acs represents an area of an arbitrary cross-section (cross-section where Av is measured) of the permanent magnet 2. The “arbitrary cross-section of the permanent magnet 2” may be the cross-section 2cs that is approximately parallel to the easy magnetization axis direction C of the permanent magnet 2. The “arbitrary cross-section of the permanent magnet 2” may be a cross-section that is approximately parallel to the AB direction of the permanent magnet 2. The “arbitrary cross-section of the permanent magnet 2” may be a cross-section that is not parallel to the easy magnetization axis direction C and the AB direction of the permanent magnet 2.

In a case where the area ratio pr of the plurality of voids 8 is larger than 0.2%, a movement of a magnetic domain wall is sufficiently suppressed by pinning of the magnetic domain wall at the voids 8, and the permanent magnet 2 can have a sufficiently high coercivity. In a case where the area ratio (pr) of the plurality of voids 8 is 2% or smaller, a decrease in a residual magnetic flux density according to formation of the voids 8 is sufficiently suppressed. That is, in a case where the area ratio (pr) of the plurality of voids 8 is larger than 0.2% and 2% or smaller, the high coercivity and the high residual magnetic flux density are compatible with each other. As the high coercivity and the high residual magnetic flux density are compatible with each other, the area ratio (pr) of the plurality of voids 8 may be from 0.255% to 1.967%. Even in a case where a content of R in the permanent magnet 2 is low, and the grain boundary phases (R-rich phases or the like) functioning as pinning sites are few, according to this embodiment, the high coercivity and the high residual magnetic flux density are compatible with each other. Even in a case where the permanent magnet 2 does not contain the heavy rare-earth elements (neither Dy nor Tb), according to this embodiment, the high coercivity and the high residual magnetic flux density are compatible with each other.

For example, a coercivity (HcJ) of the permanent magnet 2 at 23° C. may be from 1103 kA/m to 1314 kA/m, or from 997 kA/m to 1512 kA/m.

For example, a residual magnetic flux density (Br) of the permanent magnet 2 at room temperature may be from 1282 mT to 1377 mT, or from 1281 mT to 1385 mT.

For example, a squareness ratio (Hk/HcJ) of the permanent magnet 2 may be from 86.3% to 100%, or 87.6% to 95.1%. Hk is an intensity of a demagnetizing field corresponding to 90% of the residual magnetic flux density in a second quadrant of a magnetization curve.

An average value (p_avg) of an area of each of the plurality of voids 8 in an arbitrary cross-section of the permanent magnet 2 may be from 0.1 (μm)² to 7 (μm)², or from 1.665 (μm)² to 6.658 (μm)².

A standard deviation (p_std) of the area of each of the plurality of voids 8 in an arbitrary cross-section of the permanent magnet 2 may be from 0 (μm)² to 5 (μm)², or from 1.919 (μm)² to 4.988 (μm)². That is, the standard deviation of the area of each of the plurality of voids 8 existing in the arbitrary cross-section may be small. In a case where the plurality of voids 8 existing in the arbitrary cross-section have the same size (area), the standard deviation decreases. In a case where the standard deviation is within the above-described numerical value range, the high coercivity and the high residual magnetic flux density are likely to be compatible with each other, and the squareness ratio Hk/HcJ is likely to be high.

The arbitrary cross-section of the permanent magnet 2 may be a rectangular shape. The rectangular shape includes a square shape. One side among four sides of the rectangular shape is regarded as an x-axis. One side orthogonal to the X-axis among the four sides of the rectangular shape is regarded as a y-axis. An intersection between the x-axis and the y-axis is regarded as the origin.

A correlation coefficient of x and y is expressed as follows. In a coordinate system composed of the origin, the x-axis, and the y-axis, a position (coordinates) of a geometric center of each of the plurality of voids 8 is expressed as (x,y). The geometric center may also be referred to as a barycenter. From the coordinates (x,y) of the geometric center of each of all voids 8 existing in the arbitrary cross-section, a covariance Cov(x,y) of x and y, a standard deviation σₓ of the coordinate x, and a standard deviation σ_{y} of the coordinate y are calculated. The covariance Cov(x,y) is expressed by the following Mathematical Formula 1. The correlation coefficient r of x and y is expressed by the following Mathematical Formula 2 on the basis of the covariance Cov(x,y), the standard deviation σₓ, and the standard deviation α_{y}.

Cov(x,y)=E[(x−E[x])(y−E[y])] (1)

E[x] in Mathematical Formula 1 represents an expected value (average value) of x. E[y] in Mathematical Formula 1 represents an expected value (average value) of y. E[(x−E[x])(y−E[y])] in Mathematical Formula 1 represents an expected value (average value) of (x−E[x])(y−E[y]).

r=Cov(x,y)/σₓσ_{y} (2)

An absolute value of the correlation coefficient r of the coordinates (x,y) of the geometric center of each of the plurality of voids 8 may be from 0 to 0.2, or from 0.005 to 0.197. That is, the correlation coefficient r of x and y may be a value close to 0. In other words, the correlation between x and y may be weak. As a deviation of the position of each of the entirety of voids 8 existing in the arbitrary cross-section is smaller, the correlation coefficient r becomes a value closer to 0. In a case where the absolute value of the correlation coefficient r of x and y is within the above-described numerical value range, the deviation of the position of each of the voids 8 is small, and the high coercivity and the high residual magnetic flux density are likely to be compatible with each other, and the squareness Hk/HcJ is likely to be high.

In a case where the plurality of voids 8 are distributed in the permanent magnet 2 in such a manner that the average value of the area of each of the plurality of voids 8, the standard deviation of the area of each of the plurality of voids 8, and the correlation coefficient r are within the above-described ranges, a decrease in the residual magnetic flux density in accordance with formation of the plurality of voids 8 is likely to be suppressed, and the permanent magnet 2 is likely to have the high coercivity in accordance with the pinning of the magnetic domain wall at the plurality of voids 8.

For example, dimensions of the arbitrary cross-section, where the area of the plurality of voids 8, the average value of the area of each of the plurality of voids 8, the standard deviation of the area of each of the plurality of voids 8, and the absolute value of the correlation coefficient r of x and y are measured, may be 423 μm (vertical)×317 μm (horizontal).

As illustrated in FIG. 2, in the cross-section 2cs that is approximately parallel to the easy magnetization axis direction C of the permanent magnet 2, a plurality of flat main phase grains 4 may be observed. In other words, each of the main phase grains 4 observed in the cross-section 2cs may have a plate shape. The plurality of flat main phase grains 4 may be stacked along the easy magnetization axis direction C. The permanent magnet 2 may further contain a secondary grain composed of the plurality of main phase grains 4 bounded to each other. The permanent magnet 2 may contain a plurality of secondary grains. At least a part of the voids 8 may be located at a grain boundary between the plurality of secondary grains. At least a part of the R-rich phases 6 may be located at a grain boundary between the plurality of secondary grains.

Each of the main phase grains 4 includes at least R (Nd or the like), T, and B. Each of the main phase grains 4 may also be referred to as one crystal grain (that is, a primary grain). Each of the main phase grains 4 contains a crystal (a single crystal or a polycrystal) of R₂T₁₄B. The R₂T₁₄B is a ferromagnetic ternary intermetallic compound. The main phase grain 4 may consist of only the crystal of R₂T₁₄B. The crystal of the R₂T₁₄B may be tetragonal. That is, crystal axes of R₂T₁₄B are an a-axis, a b-axis, and a c-axis, the a-axis, the b-axis, and the c-axis are orthogonal to each other, a lattice constant of R₂T₁₄B in an a-axis direction may be equal to a lattice constant of R₂T₁₄B in a b-axis direction, and a lattice constant of R₂T₁₄B in a c-axis direction may be different from the lattice constants in the a-axis direction and the b-axis direction. The c-axis direction of R₂T₁₄B may be approximately parallel to the easy magnetization axis direction C of the permanent magnet 2.

The main phase grain 4 may include another element in addition to R, T, and B. For example, R₂T₁₄B constituting the main phase grain 4 may be expressed as (Nd₁₋ₓPrₓ)₂(Fe_{1-y}Co_{y})₁₄B. x may be 0 or more and less than 1. y may be 0 or more and less than 1. The main phase grain 4 may include a heavy rare-earth element such as Tb and Dy as R in addition to a light rare-earth element. A part of B in R₂T₁₄B may be substituted with another element such as carbon (C). A composition within the main phase grain 4 may be uniform. The composition within the main phase grain 4 may be non-uniform. For example, a concentration distribution of each of R, T, and B in the main phase grain 4 may have a gradient.

The main phase grain 4 may be composed of a surface layer portion and a central portion covered with the surface layer portion. The surface layer portion may be referred to as a shell, and the central portion may be referred to as a core. The surface layer portion of the main phase grain 4 may include at least one kind of heavy rare-earth element between Tb and Dy. The surface layer portions of all of the main phase grains 4 may include at least one kind of heavy rare-earth element between Tb and Dy. The surface layer portion of a part of all of the main phase grains 4 may include at least one kind of heavy rare-earth element between Tb and Dy. When the surface layer portion includes the heavy rare-earth element, an anisotropic magnetic field is likely to locally increase in the vicinity of a grain boundary, and a magnetization reversal nucleus is less likely to be generated in the vicinity of the grain boundary. As a result, the coercivity of the permanent magnet 2 at a high temperature (for example, 100° C. to 200° C.) increases. From the viewpoint that the residual magnetic flux density (Br) and the coercivity of the permanent magnet 2 are likely to be compatible with each other, a sum of the concentrations of the heavy rare-earth elements in the surface layer portion may be higher than a sum of the concentrations of the heavy rare-earth elements in the central portion.

A volume ratio of main phases (a volume ratio of all main phase grains 4 in the permanent magnet 2) is not particularly limited. For example, the volume ratio of the main phases may be 80 volume % or more and less than 99.8 volume %, 90 volume % or more and less than 99.8 volume %, or 95 volume % or more and less than 99.8 volume %. The residual magnetic flux density of the permanent magnet 2 increases in accordance with an increase in the volume ratio of the main phases.

The R-rich phase 6 may be a ferromagnetic substance, and may be a soft magnetic substance. The R-rich phase 6 includes at least R. For example, the R-rich phase 6 may include Nd as R. The R-rich phase 6 may further include one or more kinds of other rare-earth elements as R in addition to Nd. The R-rich phase 6 may further include one or more kinds of elements other than R in addition to R. The R-rich phase 6 may include at least one kind of component selected from the group consisting of a metal, an alloy, an intermetallic compound, and an oxide. For example, a part or all of the R-rich phases 6 may consist only of at least one kind of component among a simple substance of R, an R-containing alloy, and an R-containing intermetallic compound. A part or all of the R-rich phases 6 may include an R-oxide. For example, the R-oxide may be an Nd-oxide. An oxidized surface of the main phase grain 4 may be the R-oxide. A part of the R-rich phases 6 may consist only of the R-oxide.

A concentration of R in the R-rich phases 6 may be higher than an average value of a concentration of R in the main phase grains 4. The concentration of R in the R-rich phases 6 may be higher than an average value of the concentration of R in the cross-section 2cs. In a case where the permanent magnet 2 includes a plurality of kinds of R, a concentration of R may be a sum of concentrations of the plurality of kinds of R.

An average value of a length of a short axis of the main phase grains 4 (primary grains) observed in the cross-section 2cs may be from 20 nm to 200 nm, or from 110 nm to 147 nm. In a case where the average value of the length of the short axis of the main phase grains 4 is within the above-described range, anisotropic growth of each of the main phase grains 4 (crystals of R₂T₁₄B) becomes sufficient, and thus each of the main phase grains 4 is likely to be oriented in the easy magnetization axis direction C, and the coercivity, the residual magnetic flux density, and the squareness ratio are likely to increase. An average value of a length of a long axis of the main phase grains 4 (primary grains) observed in the cross-section 2cs may be, for example, from 100 nm to 1000 nm.

The short axis of each of the main phase grains 4 observed in the cross-section 2cs may be approximately parallel to the easy magnetization axis direction C. The long axis of the main phase grains 4 may be approximately orthogonal to the easy magnetization axis direction C. A shape of the main phase grain 4 in the cross-section 2cs is not limited to a rectangular shape. The shape of the main phase grains 4 in the cross-section 2cs may be distorted. The shapes of the main phase grains 4 in the cross-section 2cs do not have to be similar to each other. In a case where the shape of the main phase grain 4 in the cross-section 2cs is distorted, the shape of the main phase grains 4 may be approximated by a quadrangle having the smallest area among quadrangles circumscribing the main phase grains 4. The quadrangle may be a rectangle. A length of a short side of the quadrangle may be regarded as the length of the short axis of the main phase grain 4, and a length of a long side of the quadrangle may be regarded as the length of the long axis of the main phase grain 4. An average value of the length of the short axis of the main phase grains 4 may be calculated from measurement values of the lengths of the short axes of all of main phase grains 4 existing within a backscattered electron image of the cross-section 2cs taken by a scanning electron microscope (SEM). The average value of the length of the long axis of the main phase grains 4 may also be calculated from measurement values of the lengths of the long axes of all of main phase grains 4 existing within the backscattered electron image. However, dimensions of the main phase grains 4 protruding from the backscattered electron image are excluded from calculation of the average value. For example, the maximum value of dimensions of the backscattered electron image used for the measurement of the length of each of the short axis and the long axis of the main phase grain 4 may be, for example, 120 μm (vertical)×80 μm (horizontal), or 80 μm (vertical)×120 μm (horizontal). A plurality of representative sites within the backscattered electron image taken at a low magnification are selected, and a backscattered electron image of each of the sites may be taken at a high magnification. In addition, the average value of each of the long axis and the short axis may be calculated from a length of each of the long axis and the short axis of all of main phase grains 4 measured within the backscattered electron image at the high magnification. Commercially available image analysis software may be used for specifying of a shape (contour line) of the main phase grain 4 and the measurement of dimensions of the main phase grain 4 (a quadrangle circumscribing the main phase grain 4).

A dimension of the permanent magnet 2 in the easy magnetization axis direction C may be, for example, from several mm to several hundreds of mm, or from several tens of mm to several hundreds of mm A dimension of the permanent magnet 2 in the AB direction may be, for example, from several mm to several hundred of mm, or from several tens of mm to several hundreds of mm

A grain boundary phase other than the R-rich phase 6 may be contained in the grain boundary. For example, the grain boundary may contain a grain boundary phase containing an element introduced into the permanent magnet 2 by a grain boundary diffusion step to be described later. The element introduced into the permanent magnet 2 by the grain boundary diffusion step may be at least one kind of heavy rare-earth element between Tb and Dy. The element introduced into the permanent magnet 2 by the grain boundary diffusion step may be a heavy rare-earth element and a light rare-earth element, and the light rare-earth element may be at least one between Nd and Pr. The element introduced into the permanent magnet 2 by the grain boundary diffusion step may be a heavy rare-earth element, a light rare-earth element, and copper.

A long-axis-direction length of each of the voids 8, which are observed in an arbitrary cross-section of the permanent magnet 2, is expressed as L_{L}. A short-axis-direction length of the void 8 is expressed as L_{S}. An aspect ratio of the void 8 is expressed as L_{L}/L_{S}. An average value of L_{L}/Lₛ may be from 1 to 2, from 1.124 to 1.786, or from 1.124 to 1.435.

The void 8 in which L_{L}/Lₛ exceeds 2 has an elongated shape in one axial direction. The void 8 in which L_{L}/L_{S} exceeds 2 is less likely to contribute to an increase in the coercivity. Although the reason for this is not clear, the present inventors assume that the short-axis-direction length Lₛ of the void 8 in which L_{L}/Lₛ exceeds 2 is likely to be smaller than a size of a magnetic domain and the void 8 with L_{L}/Lₛ exceeding 2 is less likely to hinder a magnetization reversal process. On the other hand, it is assumed that the void 8 with L_{L}/L_{S} of 2 or less has a shape expanding substantially evenly in both the easy magnetization axis direction C and the AB direction and thus the void 8 can hinder the magnetization reversal process in both the easy magnetization axis direction C and the AB direction. Accordingly, the void 8 with L_{L}/Lₛ of 2 or less is likely to contribute to an increase in the coercivity. For the above-described reason, an average value of L_{L}/L_{S} is preferably from 1 to 2, and the average value of L_{L}/L_{S} is preferably close to 1.

Each of the main phase grains 4, the voids 8, and the R-rich phases 6 can be identified on the basis of contrast of an image of the cross-section 2cs of the permanent magnet 2 taken by scanning electron microscope (SEM) or scanning transmission electron microscope (STEM). A composition of each of the main phase grains 4 and the R-rich phases 6 may be analyzed by an electron beam probe micro analyzer (EPMA) equipped with an energy dispersive X-ray spectroscopy (EDS) device.

A composition of the entirety of the permanent magnet 2 will be described below. However, the composition of the permanent magnet 2 is not limited to the following composition. A content of each element in the permanent magnet 2 may be out of the following range.

A content of R in the R-T-B based permanent magnet may be from 28.00 mass % to 33.00 mass %. When the content of R is within the above-described range, the residual magnetic flux density and the coercivity of the permanent magnet 2 are likely to increase. In a case where the content of R is 28.00 mass % or more, it is easy to suppress cracks formed in the permanent magnet 2 in a hot plastic deforming step. In a case where the content of R is 28.00 mass % or more, R₂T₁₄B constituting the main phase grain 4 is likely to be formed, and an a-Fe phase having soft magnetism is less likely to be formed. As a result, the coercivity is likely to increase. On the other hand, in a case where the content of R is 33.00 mass % or less, segregation of a liquid phase (R-rich phase) on a surface of the permanent magnet 2 is suppressed in the hot plastic deforming step, and seizure of a mold and the permanent magnet 2 is suppressed. In a case where the content of R is 33.00 mass % or less, formation of the R-rich phases 6 is appropriately suppressed, and the residual magnetic flux density is likely to increase. From the viewpoint that the residual magnetic flux density and the coercivity are likely to increase, a sum of ratios of Nd and Pr in all rare-earth elements R may be from 80 atomic % to 100 atomic %, or from 95 atomic % to 100 atomic %.

A total content of Tb and Dy in the permanent magnet 2 may be from 0.00 mass % to 5.00 mass %. When the permanent magnet 2 includes at least one kind of heavy rare-earth element between Tb and Dy, magnetic characteristics (particularly, a coercivity at a high temperature) of the permanent magnet 2 are likely to increase. However, the permanent magnet 2 does not have to include Tb and Dy.

A content of B in the R-T-B based permanent magnet may be from 0.75 mass % to 1.20 mass %. In a case where the content of B is 0.75 mass % or more, formation of a heterogeneous phase such as an R₂Fe₁₇ phase is suppressed, and the coercivity and the residual magnetic flux density are likely to increase. In a case where the content of B is 1.20 mass % or less, formation of a heterogeneous phase such as R_{1+ε}Fe₄B₄ (boride) is suppressed, and the coercivity and the residual magnetic flux density are likely to increase. In a case where the content of B is within the above-described range, the squareness ratio of the permanent magnet 2 is likely to be close to 1.0.

In a case where a sum of contents of the rare-earth elements R in the permanent magnet 2 is from 28.00 mass % to 33.00 mass %, and the content of B in the permanent magnet 2 is from 0.75 mass % to 1.20 mass %, the sum of contents of the rare-earth elements R in the permanent magnet 2 is more than a chemical stoichiometric ratio of R₂T₁₄B. As a result, a liquid phase is likely to be generated in a grain boundary in the hot plastic deforming step to be described later. The liquid phase in the grain boundary promotes anisotropic growth of a crystal grain (R₂T₁₄B), grain boundary sliding, and rotation of the crystal grain. As a result, a c-axis of the crystal grain is likely to be oriented in a stress direction, a volume ratio of a main phase is likely to increase, and the coercivity and the residual magnetic flux density of the permanent magnet 2 are likely to increase.

The permanent magnet 2 may include gallium (Ga). A content of Ga may be from 0.03 mass % to 1.00 mass %, or from 0.20 mass % to 0.80 mass %. In a case where the content of Ga is within the above-described range, generation of a sub-phase (for example, phases including R, T, and Ga) is appropriately suppressed, and the residual magnetic flux density and the coercivity of the permanent magnet 2 are likely to increase. However, the permanent magnet 2 does not have to include Ga.

The permanent magnet 2 may include aluminum (Al). A content of Al in the permanent magnet 2 may be from 0.01 mass % to 0.2 mass %, or from 0.04 mass % to 0.07 mass %. When the content of Al is within the above-described range, the coercivity and corrosion resistance of the permanent magnet are likely to be improved. However, the permanent magnet 2 does not have to include Al.

The permanent magnet 2 may include copper (Cu). A content of Cu in the permanent magnet 2 may be from 0.01 mass % to 1.50 mass %, or from 0.04 mass % to 0.50 mass %. When the content of Cu is within the above-described range, the coercivity, the corrosion resistance, and temperature characteristics of the permanent magnet 2 are likely to be improved. However, the permanent magnet 2 does not have to include Cu.

The permanent magnet 2 may include cobalt (Co). A content of Co in the permanent magnet may be from 0.30 mass % to 6.00 mass %, or from 0.30 mass % to 4.00 mass %. When the permanent magnet 2 includes Co, a Curie temperature of the permanent magnet 2 is likely to be heightened. In addition, when the permanent magnet 2 includes Co, the corrosion resistance of the permanent magnet 2 is likely to be improved. However, the permanent magnet 2 does not have to include Co.

A balance excluding the above-described elements from the permanent magnet 2 may be only Fe, or Fe and other elements. A sum of contents of elements other than Fe in the balance may be 5 mass % or less with respect to the total mass of the permanent magnet 2 so that the permanent magnet 2 has sufficient magnetic characteristics.

The permanent magnet 2 may include at least one kind selected from the group consisting of silicon (Si), titanium (Ti), manganese (Mn), zirconium (Zr), vanadium (V), chromium (Cr), nickel (Ni), niobium (Nb), molybdenum (Mo), hafnium (Hf), tantalum (Ta), tungsten (W), bismuth (Bi), tin (Sn), calcium (Ca), carbon (C), nitrogen (N), oxygen (O), chlorine (Cl), sulfur (S), and fluorine (F) as the other elements (for example, inevitable impurities). A sum of contents of the other elements in the permanent magnet 2 may be from 0.001 mass % to 0.50 mass %.

A composition of the entirety of the permanent magnet 2 may be analyzed, for example, by an X-ray fluorescence (XRF) analysis method, a high-frequency inductively coupled plasma (ICP) emission analysis method, an inert gas fusion-non-dispersive infrared absorption (NDIR) method, a combustion in an oxygen stream-infrared absorption method, an inert gas fusion-thermal conductivity method, and the like.

The permanent magnet 2 may be applied to a motor, a generator, an actuator, or the like. For example, the permanent magnet 2 is used in various fields such as a hybrid vehicle, an electric vehicle, a hard disk drive, a magnetic resonance imaging (MRI) device, a smartphone, a digital camera, a slim-type TV, a scanner, an air conditioner, a heat pump, a refrigerator, a cleaner, a washing and drying machine, an elevator, and a wind power generator.

(Method of Producing Permanent Magnet)

A method of producing a permanent magnet according to this embodiment includes at least a ribbon preparation step, a hot pressing step, a hot plastic deforming step, and a cooling step. The method of producing the permanent magnet may further include another step such as a grain boundary diffusion step subsequent to the cooling step. However, the grain boundary diffusion step is not essential.

The method of producing the permanent magnet may be executed under a non-oxidizing atmosphere to prevent the permanent magnet and its work-in progress from oxidation during the producing process. For example, the non-oxidizing atmosphere may be an inert gas such as an argon (Ar) gas. The non-oxidizing atmosphere may further contain a reducing gas such as a hydrogen gas (H₂) in addition to the inert gas.

The ribbon preparation step is a step of preparing alloy ribbons from a raw material metal by a rapid-solidification method. In the rapid-solidification method, a molten metal in a crucible is ejected to a surface of a cooled roll from a nozzle located at a tip end of the crucible. The molten metal comes into contact with the surface of the cooled roll, and the molten metal is instantly flicked by the cooled roll rotating at a high speed, then becomes a plurality of elongated ribbon patterns. Due to contact with the surface of the cooled roll, the molten metal is rapidly cooled and solidifies. As a result, the plurality of elongated alloy ribbons are formed. A container is set up in a direction in which the alloy ribbons are flicked by the cooled roll, and the alloy ribbons are collected into the container.

The molten metal is a metal (raw material metals) containing respective elements constituting the permanent magnet. For example, the raw material metal may be a simple substance of a rare-earth element (simple substance of a metal); an alloy including a rare-earth element; pure iron; ferroboron; or an alloy including these materials. The raw material metals are weighed to match a desired composition of the permanent magnet.

The molten metal may be obtained by heating the raw material metals inside a crucible by high-frequency inductive heating. A temperature (ejection temperature) of the molten metal ejected from a nozzle is, for example, approximately 1400° C. A temperature rising rate until the temperature of the raw material metal reaches the ejection temperature is, for example, approximately from 20° C./second to 100° C./second.

The surface of the cooled roll may be composed of a metal such as Cu having high thermal conductivity. A temperature of the surface of the cooled roll may be controlled by a coolant flowing through the inside of the cooled roll. For example, the temperature of the surface of the cooled roll may be controlled so that a cooling rate of the molten metal on the surface of the cooled roll becomes approximately 10⁵° C./second to 10⁶° C./second. The higher the cooling rate is, the more a grain size of a crystal (R₂T₁₄B) contained in the alloy ribbon is likely to be finer, and the coercivity of the permanent magnet is likely to be higher. The smaller the amount of the molten metal ejected to the surface of the cooled roll per unit time is, the molten metal adhered to the surface of the cooled roll becomes thinner, the cooling rate becomes higher, and the alloy ribbon becomes thinner. The higher a peripheral speed of the cooled roll becomes, the molten metal adhered to the surface of the cooled roll becomes thinner, the cooling rate becomes higher, and the alloy ribbon becomes thinner. A thickness of the main phase grain in the easy magnetization axis direction (length of the short axis of the main phase grain) depends on a thickness of the alloy ribbon (and pulverization and classification of the alloy ribbon). The thinner the alloy ribbon is, the thickness (grain size) of the main phase grain becomes smaller, and the coercivity of the permanent magnet tends to be higher. For example, the thickness of the alloy ribbon may be from 20 μm to 60 μm, or from 30 μm to 50 μm. For example, a width of the alloy ribbon may be from 1.0 mm to 5.0 mm.

After the ribbon preparation step, a pulverization/classification step may be carried out. The pulverization/classification step is a step of pulverizing the alloy ribbons by using a pulverization device to prepare a coarse powder, and of classifying the coarse powder to collect an alloy powder having a predetermined particle size and a predetermined aspect ratio. The alloy powder is a precursor of the main phase grain contained in the permanent magnet. A shape of each alloy particle constituting the alloy powder may be a plate shape or a flake shape. For example, a pulverization method of the alloy ribbon may be at least one method between a cutter mill and a propeller mill. A mean for classification of the coarse powder is a sieve. For example, the particle size and a particle size distribution of the alloy powder obtained through classification may be measured by a laser diffraction scattering method. For example, the particle size of the alloy powder obtained through classification may be from 60 μm to 2800 μm, or from 150 μm to 2800 μm.

The hot pressing step is a step of forming a green compact by heating and pressing the alloy ribbons (alloy powder). For example, the alloy powder may be compressed inside of a mold while heating the alloy powder inside the mold. Due to pressing of the alloy powder, voids between alloy powders are reduced and a dense green compact is obtained. In addition, due to heating of the alloy powder along with the pressing, a liquid phase (R-rich phase such as Nd-rich phase) is formed from a surface of the alloy powder, the voids (grain boundaries) between the alloy powders are filled with the liquid phase, and the alloy powders are lubricated due to the liquid phase, and thus the dense green compact is obtained. A cold pressing step may be carried out before the hot pressing step. In the cold pressing step, a green compact may be formed by pressing the alloy powder at an ordinary temperature (room temperature). The green compact obtained by the cold pressing step may be pressed while being heated in the hot pressing step to densify the green compact. For example, a temperature (hot pressing temperature) of the alloy powder in the hot pressing step may be from 550° C. to 800° C. In a case where the hot pressing temperature is too low, a sufficient amount of liquid phase is not formed from the surface of the alloy powder, and the green compact is less likely to be densified. In a case where the hot pressing temperature is excessively high, grain growth of the crystal (R₂T₁₄B) constituting the alloy powder excessively progresses, and the coercivity of the permanent magnet decreases. A pressure (hot pressing pressure) applied to the alloy powder in the hot pressing step may be from 50 MPa to 200 MPa. A time (hot pressing time) for which the hot pressing temperature and the hot pressing pressure are maintained within the above-described ranges may be, for example, from several tens of seconds to several hundreds of seconds.

After the hot pressing step, the hot plastic deforming step is carried out. The hot plastic deforming step is a step of obtaining a magnet base material containing a plurality of main phase grains (crystal grains of R₂T₁₄B), in which the c-axis (easy magnetization axis) is oriented in a predetermined direction, through hot extrusion of the green compact obtained by the hot pressing step. For example, in the hot plastic deforming step, the green compact is extruded from a mold while heating the green compact. In the mold, a grain boundary phase in the heated green compact liquefies and a liquid phase (R-rich phase) is generated, and a stress is applied to the green compact in a predetermined direction, and respective alloy particles constituting the green compact are distorted. In accordance with generation of the liquid phase and distortion of the alloy particles, anisotropic growth of crystal grains in a direction orthogonal to the c-axis of the crystal grains progresses. In addition, the liquid phase lubricates the crystal grains, and thus a force is applied to respective crystal grains in accordance with the stress. As a result, the crystal grains rotate due to grain boundary sliding, and the c-axis of respective crystal grains (main phase grains) is oriented approximately in parallel to a stress direction. In other words, a plurality of flat main phase grains extending in a direction that is approximately orthogonal to the c-axis are stacked along the stress direction.

A temperature (hot plastic deforming temperature) of the green compact in the hot plastic deforming step may be, for example, 700° C. or higher and lower than 900° C., or from 700° C. to 850° C.

In a case where the hot plastic deforming temperature is too low, the liquid phase (the R-rich phase such as the Nd-rich phase) is less likely to be generated at a grain boundary inside the green compact, crystal grains are less likely to be grown, and rotation of crystal grains due to grain boundary sliding is less likely to occur. As a result, an average value of the length of the short axis of the main phase grain is likely to be less than 20 nm, and the c-axis of the main phase grains (crystal grains) is less likely to be oriented in approximately parallel to the stress direction.

In a case where the hot plastic deforming temperature is excessively high (for example, in a case where the hot plastic deforming temperature is 900° C. or higher), the liquid phase (the R-rich phase) excessively exudes from each of the alloy particles and segregates to the surface of each of the alloy particles and an interface between the alloy particles, and most of the liquid phase is consumed for grain growth of crystal grains. When most of the liquid phase is consumed for grain growth of crystal grains, grain growth of the main phase grains (crystal grains) progresses abnormally, and a coarse main phase grain is likely to be formed, and the average value of the length of the short axis of the main phase grains is likely to exceed 200 nm. The coarse main phase grain is less likely to be oriented in the easy magnetization axis direction.

An extrusion rate in the hot extrusion may be from 10⁻² mm/second to 9.9 mm/second. In a case where the extrusion rate is excessively high (for example, in a case where the extrusion rate is 10 mm/second or more), anisotropic growth of the main phase grains (crystal grains) inside the green compact does not progress sufficiently, and thus the average value of the length of the short axis of the main phase grains (primary grains) is likely to be less than 20 nm. That is, in a case where the extrusion rate is excessively high, the green compact is extruded from the mold before the anisotropic growth of the crystal grains inside the green compact progresses sufficiently. As a result, the c-axis of the main phase grains (crystal grains) is less likely to be oriented approximately in parallel to the stress direction.

A pressure (hot plastic deforming pressure) applied to the green compact in the hot plastic deforming step may be from 50 MPa to 200 MPa. For example, a time (hot plastic deforming time) for which the hot plastic deforming temperature and the hot plastic deforming pressure are maintained within the above-described ranges may be several tens of seconds.

The mold used for the hot plastic deforming step has a tubular shape. That is, a cavity formed inside the mold passes through the mold from an end surface (starting end surface) of the mold where an inlet for the green compact is opened toward an end surface (terminal end surface) of the mold where an extrusion port for the green compact is opened. The starting end surface and the terminal end surface are planes parallel to each other. A direction from the starting end surface to the terminal end surface is an extrusion direction of the green compact, and the extrusion direction is orthogonal to the starting end surface and the terminal end surface. An opening area of the extrusion port of the green compact is smaller than an opening area of the inlet of the green compact.

A specific example of the cavity formed inside the mold is illustrated in FIG. 3. The cavity 10 is sectioned into an inlet side region 10A, an intermediate region 10B, and an extrusion port side region 10C along an extrusion direction (Z-axis direction). The inlet side region 10A is opened at the starting end surface. The extrusion port side region 10C is opened at the terminal end surface. The intermediate region 10B is located between the inlet side region 10A and the extrusion port side region 10C in the extrusion direction.

A shape of the cavity 10 in a cross-section of the mold that is orthogonal to the extrusion direction (cross-section of the mold that is parallel to the starting end surface and the terminal end surface) is a quadrilateral of which four corners are right angles. A pair of sides facing each other in the quadrilateral is noted as a first side, and another pair of sides facing each other in the quadrilateral is noted as a second side.

A length xa of the first side in the inlet side region 10A is constant. A length ya of the second side in the inlet side region 10A is also constant. That is, an opening area of the inlet side region 10A in a cross-section orthogonal to an extrusion direction is constant. In the intermediate region 10B, the length xa of the first side gradually decreases along the extrusion direction, and finally, the length xa approximately matches a length xc of the first side in the extrusion port side region 10C. Accordingly, the first side in the extrusion port side region 10C is shorter than the first side in the inlet side region. In addition, in the intermediate region 10B, the length ya of the second side gradually increases along the extrusion direction, and finally, the length ya approximately matches a length yc of the second side in the extrusion port side region 10C. Accordingly, the second side in the extrusion port side region 10C is longer than the second side in the inlet side region 10A. In addition, an opening area of the intermediate region 10B in a cross-section orthogonal to the extrusion direction gradually decreases along the extrusion direction, and finally, the opening area matches an opening area of the extrusion port side region 10C in a cross-section orthogonal to the extrusion direction. Accordingly, the opening area of the extrusion port side region 10C in the cross-section orthogonal to the extrusion direction is smaller than the opening area of the inlet side region 10A in the cross-section orthogonal to the extrusion direction. The length xc of the first side in the extrusion port side region 10C is approximately constant. The length yc of the second side in the extrusion port side region 10C is also approximately constant. That is, the opening area of the extrusion port side region 10C in the cross-section orthogonal to the extrusion direction is approximately constant.

As described above, the opening area of the extrusion port side region 10C in the cross-section orthogonal to the extrusion direction is smaller than the opening area of the inlet side region 10A in the cross-section orthogonal to the extrusion direction, and the first side in the extrusion port side region 10C (terminal end surface) is shorter than the second side in the extrusion port side region 10C (terminal end surface). In the intermediate region 10B, the length xa of the first side gradually decreases along the extrusion direction, and in the intermediate region 10B, the length ya of the second side gradually increases along the extrusion direction. Accordingly, in the intermediate region 10B and the extrusion port side region 10C, a stress that is approximately parallel to the first side acts on the green compact, and grain boundary sliding and rotation of the main phase grain occur. As a result, the c-axis of main phase grain is oriented along a stress direction (direction of the first side). That is, the easy magnetization axis direction C of the magnet base material obtained by the hot extrusion approximately matches the direction (x-axis direction) of the first side in the extrusion port side region 10C (terminal end surface).

The magnet base material expands in accordance with reduction or release of the pressure applied to the magnet base material after the hot plastic deforming step. The main phase grain 4 and the grain boundary phase (R-rich phase 6 or the like) in the magnet base material are different in the degree of spring back. That is, the main phase grain 4 and the grain boundary phase (R-rich phase 6 or the like) in the magnet base material are different in the amount of expansion in accordance with a reduction of a pressure. In addition, the main phase grain 4 and the grain boundary phase (R-rich phase 6 or the like) in the magnet base material are also different in a coefficient of thermal expansion. That is, the main phase grain 4 and the grain boundary phase (R-rich phase 6 or the like) in the magnet base material are different in the amount of contraction in accordance with cooling-down. Due to these factors, the plurality of voids 8 are formed in the magnet base material.

In the cooling step subsequent to the hot plastic deforming step, the magnet base material is not heated, and the magnet base material is pressed continuously for a predetermined time (pressing time t). That is, the cooling step is a step of releasing a pressure applied to the magnet base material during the magnet base material's natural cooling after applying a predetermined pressure Pc to the magnet base material for the pressing time t. The pressure Pc in the cooling step is approximately parallel to the easy magnetization axis direction C of the magnet base material. In accordance with an increase of the pressure Pc in the cooling step, the area ratio (pr) of the plurality of voids 8 tends to decrease. For example, the pressure Pc in the cooling step may be from 20 MPa to 50 MPa. In a case where the pressure Pc in the cooling step is within the above-described range, the area ratio (pr) of the plurality of voids 8 is likely to be controlled to a range of larger than 0.2% and 2% or smaller. In a case where the pressure Pc in the cooling step is within the above-described range, the average value (p_avg) of an area of each of the plurality of voids 8, the standard deviation (p_std) of the area of each of the plurality of voids 8, and the absolute value of the correlation coefficient r of x and y are likely to be controlled to the above-described ranges. The area ratio (pr) of the plurality of voids 8 tends to decrease in accordance with an increase of the pressing time tin the cooling step. For example, the pressing time t in the cooling step may be from 60 seconds to 240 seconds. In a case where the pressing time t in the cooling step is within the above-described range, the area ratio (pr) of the plurality of voids 8 is likely to be controlled to a range of larger than 0.2% and 2% or smaller. In a case where the pressing time t in the cooling step is within the above-described range, the average value (p_avg) of the area of each of the plurality of voids 8, the standard deviation (p_std) of the area of each of the plurality of voids 8, and the absolute value of the correlation coefficient r of x and y are likely to be controlled to the above-described ranges. In a case where the pressure Pc in the cooling step is excessively large, the area ratio (pr) of the voids 8 decreases due to elimination of fine voids, but the degree of local plastic deformation inside the magnet base material is greatly different from the degree of plastic deformation of other sites. Due to the local excessive plastic deformation, a small number of large voids 8 or a small number of cracks are likely to be formed. Accordingly, in a case where the pressure Pc in the cooling step is excessively large, the average value of the area of each of the plurality of voids 8 is likely to increase.

The magnet base material obtained through the above-described steps may be a finished product of the permanent magnet. The magnet base material subjected to the following grain boundary diffusion step may be the finished product of the permanent magnet.

After the cooling step, the following grain boundary diffusion step may be carried out. The grain boundary diffusion step is a step of attaching a diffusion material containing a heavy rare-earth element to a surface of the magnet base material and heating the diffusing material and the magnet base material. Due to heating of the magnet base material to which the diffusing material is attached, the heavy rare-earth element in the diffusing material diffuses from the surface of the magnet base material to the inside of the magnet base material. The heavy rare-earth element diffuses to the vicinity of the surface of the main phase grains through the grain boundaries inside of the magnet base material. In the vicinity of the surface of the main phase grains, a part of the light rare-earth element (Nd or the like) is substituted with the heavy rare-earth element. When the heavy rare-earth element locally exists in the vicinity of the surface of the main phase grains and the grain boundaries, an anisotropic magnetic field locally increases in the vicinity of the grain boundaries, and a nucleus of magnetization reversal is less likely to occur in the vicinity of the grain boundaries. As a result, a permanent magnet having a high coercivity is obtained.

A temperature (diffusion temperature) of the diffusion material and the magnet base material in the grain boundary diffusion step may be, for example, from 550° C. to 900° C. A time (diffusion time) for which the diffusion temperature is maintained in the above-described range may be, for example, from one minute to 1440 minutes.

The diffusing material may include at least one kind of heavy rare-earth element between Tb and Dy. The diffusing material may further include at least one light rare-earth element between Nd and Pr in addition to the heavy rare-earth element. The diffusing material may further include Cu in addition to the heavy rare-earth element and the light rare-earth element. For example, the diffusing material may be a metal consisting of one kind of the above-described element, a hydride of one kind of the above-described element, an alloy containing a plurality of kinds of the above-described elements, or a hydride of the alloy. The diffusing material may be a powder. In the grain boundary diffusion step, a slurry containing the diffusing material and an organic solvent may be applied to the surface of the magnet base material. In the grain boundary diffusion step, the surface of the magnet base material may be covered with a sheet containing the diffusing material and a binder. In the grain boundary diffusion step, the surface of the magnet base material may be covered with an alloy foil (ribbon) composed of the diffusing material.

To promote diffusion of the diffusing material, the surface of the magnet base material may be polished before the grain boundary diffusion step. To remove the diffusing material remaining on the surface of the magnet base material after the grain boundary diffusion step, the surface of the magnet base material after the grain boundary diffusion step may be polished.

Dimensions and a shape of the magnet base material may be adjusted by grinding and polishing the magnet base material, or the like. A passive layer may be formed on the surface of the magnet base material by oxidation or a chemical treatment of the surface of the magnet base material. The surface of the magnet base material may be covered with a protective film such as a resin film. Corrosion resistance of the permanent magnet is improved by the passive layer or the protective film.

The present invention is not necessarily limited to the above-described embodiment. Various modifications of the present invention can be made within a range not departing from the gist of the present invention, and modification examples thereof are also included in the present invention.

### EXAMPLES

The present invention will be described in detail by the following examples and comparative examples. The present invention is not limited to the following examples.

<Preparation of Permanent Magnet>

### Example 1

Each step in the following Example 1 was carried out in a non-oxidizing atmosphere (Ar gas).

In a ribbon preparation step, an alloy powder (alloy ribbon) was prepared from a raw material metal by the rapid-solidification method. The raw material metal (molten metal) used in the ribbon preparation step included Nd, Fe, Co, Ga, Al, and B.

A content of Nd in the raw material metal was 30.17 mass %.

A content of Co in the raw material metal was 3.96 mass %.

A content of Ga in the raw material metal was 0.59 mass %.

A content of Al in the raw material metal was 0.04 mass %.

A content of B in the raw material metal was 0.97 mass %.

A balance of the raw material metal except for Nd, Co, Ga, Al, and B was Fe.

In the hot pressing step, the alloy powder inside the mold was compressed with the mold while being heated to prepare a green compact. The green compact was a cube. Dimensions of the green compact were 10 mm×10 mm×10 mm. The hot pressing temperature was 660° C. The hot pressing pressure was 100 MPa. The hot pressing time was 240 seconds.

The hot plastic deforming step subsequent to the hot pressing step was carried out. In the hot plastic deforming step, the magnet base material was prepared through hot extrusion of the green compact by using the above-described mold (mold in which the cavity 10 shown in FIG. 3 is formed). The length xc of the first side in the extrusion port side region 10C (terminal end surface) was 7 mm. The length yc of the second side in the extrusion port side region 10C (terminal end surface) was 30 mm.

A plastic deforming degree D defined by the following Mathematic Formula 3 was 70%. Lf in Mathematical Formula 3 is a dimension of the magnet base material in the easy magnetization axis direction of the magnet base material. Li in Mathematic Formula 3 is a dimension (that is, 10 mm) of the green compact in a direction corresponding to the easy magnetization axis direction of the magnet base material.

D=(Li−Lf)/Li (3)

A temperature of the mold in the hot plastic deforming step was 750° C. The hot plastic deforming pressure (maximum pressure) was 60 MPa. The extrusion rate in the hot extrusion was 0.1 mm/second.

The cooling step subsequent to the hot plastic deforming step was carried out. In the cooling step, an approximately constant pressure Pc was applied to the magnet base material in a direction approximately parallel to the easy magnetization axis direction C of the magnet base material by using a press machine. The pressure Pc in the cooling step was a value shown in Table 1. Pressing time t in the cooling step (time for which the pressure Pc is maintained) was a value shown in the following Table 1. A rain speed Vc (critical rain speed) of the press machine used in the cooling step was a value shown in the following Table 1.

A permanent magnet of Example 1 was prepared by the above-described method.

### Examples 2 to 10, and Comparative Examples 1 and 2

The pressure Pc in the cooling step of each of Examples 2 to 10 and Comparative Example 2 was a value shown in Table 1. The pressing time t in the cooling step of each of Examples 2 to 10 and Comparative Example 2 was a value shown in the following Table 1. The rain speed Vc in the cooling step of each of Examples 2 to 10 and Comparative Example 2 was a value shown in the following Table 1. In a case of Comparative Example 1, the pressure Pc in the cooling step was not applied to the magnet base material, and natural cooling of the magnet base material was carried out. A permanent magnet of each of Examples 2 to 10 and Comparative Examples 1 and 2 was prepared by a similar method as in Example 1 except for the cooling step.

<Analysis of Permanent Magnet>

(Composition and Microstructure of Permanent Magnet)

A cross-section of the permanent magnet of each of Examples 1 to 10 and Comparative Examples 1 and 2 was observed with a scanning electron microscope (SEM). The observed cross-section of the permanent magnet was parallel to the easy magnetization axis direction of the permanent magnet. A composition of the cross-section of the permanent magnet was analyzed with an electron beam probe micro analyzer (EPMA) and an energy dispersive X-ray spectroscopy (EDS) device.

Even in any case of Examples 1 to 10 and Comparative Examples 1 and 2, the permanent magnet had the following characteristics.

The permanent magnet contained a plurality of main phase grains (Nd₂Fe₁₄B crystal grains).

The R-rich phases (Nd-rich phases) were formed in the grain boundaries.

A plurality of voids were formed in the permanent magnet.

Each main phase grain observed in the cross-section was flat.

A plurality of the main phase grains were stacked along the easy magnetization axis direction.

(Dimensions of Main Phase Grain)

A backscattered electron image of the cross-section of the permanent magnet of each of Examples 1 to 10 and Comparative Examples 1 and 2 was taken with the SEM. The cross-section where the backscattered electron image was taken was parallel to the easy magnetization axis direction. Dimensions of the backscattered electron image were 88 μm (vertical)×126 μm (horizontal). A plurality of representative sites within the backscattered electron image were selected, and the backscattered electron image of each of the sites was captured at a high magnification. A length of each of a long axis and a short axis of each of main phase grains (primary grains) existing within the high magnification backscattered electron image was measured. A shape of each of the main phase grains was approximated by a rectangular shape with the smallest area among rectangular shapes circumscribing the main phase grain. A length of the long side of the rectangular shape was regarded as the length of the long axis of the main phase grain, and a length of a short side of the rectangular shape was regarded as the length of the short axis of the main phase grain. An average value Lc of the length of the short axis of all main phase grains existing within the backscattered electron image at the high magnification was calculated. The average value Lc of the length of the short axis of the main phase grains (primary grains) of each of Examples 1 to 10 and Comparative Examples 1 and 2 is shown in the following Table 1.

(Measurement on Voids)

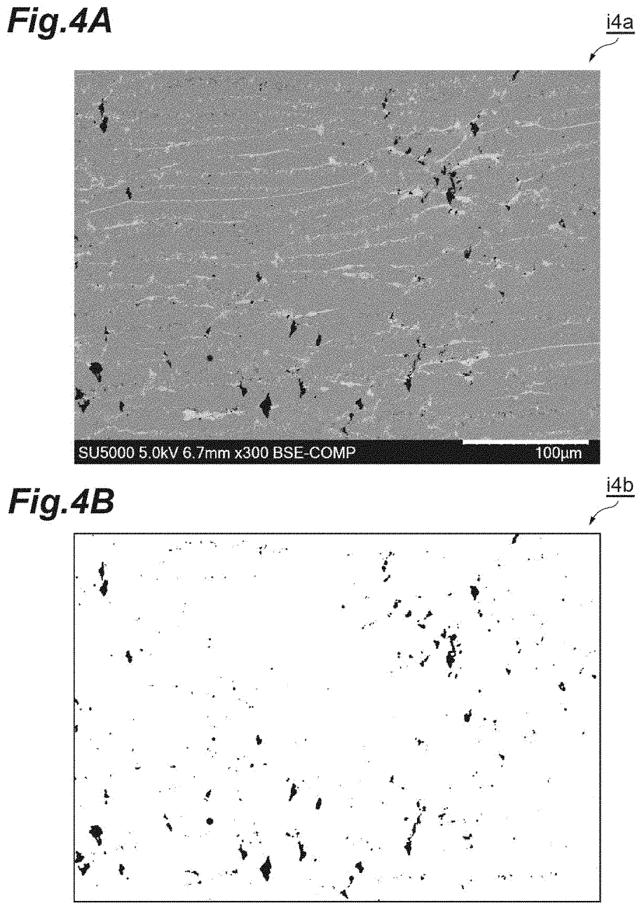

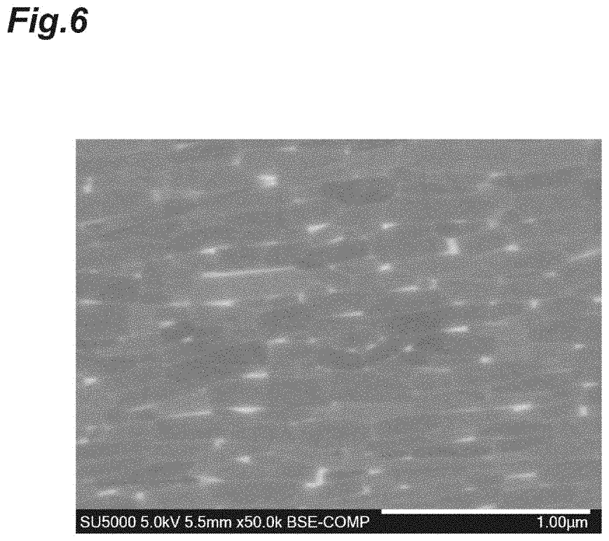

As illustrated in FIG. 4A, a backscattered electron image i4a of a part of the cross-section of the permanent magnet of Example 4 was taken with the SEM. The cross-section where the backscattered electron image i4a of Example 4 was taken was parallel to the easy magnetization axis direction. An image i4b in FIG. 4B, an image i4c in FIG. 5A, and an image i4d in FIG. 5B are images obtained from the backscattered electron image i4a of Example 4. A backscattered electron image of a part of the cross-section of the permanent magnet of Example 4 taken at a higher magnification in comparison to the backscattered electron image i4a is shown in FIG. 6.

A luminance (unit: arbitrary unit) of a backscattered electron beam at an arbitrary portion of the backscattered electron image i4a increases in accordance with an increase in an atomic weight of an element existing at the arbitrary portion. The luminance of the backscattered electron beam at the arbitrary portion of the backscattered electron image i4a increases in accordance with an increase in a concentration of an element existing at the arbitrary portion. Accordingly, a relatively bright portion in the backscattered electron image i4a is a portion where the concentration of an element (for example, Nd) having a relatively large atomic weight is relatively high. On the other hand, the darkest portion in the backscattered electron image i4a is a void where an element does not exist.

A monochrome image i4b was obtained by threshold processing (binarization processing) of the backscattered electron image i4a based on an RGB (Red-Green-Blue) color model. Dark portions in the monochrome image i4b are voids. An area of each of all voids in the monochrome image i4b was measured. An area ratio (pr) of a plurality of the voids in the cross-section (the backscattered electron image i4a) of the permanent magnet, an average value (p_avg) of the area of each of the plurality of voids in the same cross-section, and a standard deviation (p_std) of the area of each of the plurality of voids were calculated on the basis of the measured area of each of the voids. The area ratio (pr), the average value (p_avg) of the area, and the standard deviation (p_std) of the area of Example 4 are shown in Table 1.

A contour of each of the voids in the image i4b was specified by image processing of the monochrome image i4b. Each of a plurality of closed curves included in the image i4c corresponds to a contour of each of the voids in the image i4b.

Coordinates (x,y) of a geometric center of each of the voids was specified from the contour of each of the voids in the image i4c. Each dot included in the image i4d represents the coordinates (x,y) of the geometric center of each of the voids. A position of each of the voids in the image i4c matches coordinates of each dot in the image i4d. A correlation coefficient r of x and y was calculated from the coordinates (x,y) of the geometric center of each of the voids. The correlation coefficient r of Example 4 is shown in the following Table 1.

The above-described image processing of Example 4 was carried out by Image J that is an image processing software of a public domain.

An average value of an aspect ratio (L_{L}/L_{S}) of the voids of Example 4 was measured by the above-described image processing of Example 4. The average value of L_{L}/Lₛ of Example 4 is shown in the following Table 1.

An area ratio (pr), an average value (p_avg) of an area, a standard deviation (p_std) of the area, a correlation coefficient r, and an average value of L_{L}/L_{S} in each of Examples 1 to 3, Examples 5 to 10, and Comparative Examples 1 and 2 were calculated in a similar method as in Example 4. The area ratio (pr), the average value (p_avg) of the area, the standard deviation (p_std) of the area, the correlation coefficient r, and the average value of L_{L}/L_{S} in each of Examples 1 to 3, Examples 5 to 10, and Comparative Examples 1 and 2 are shown in the following Table 1.

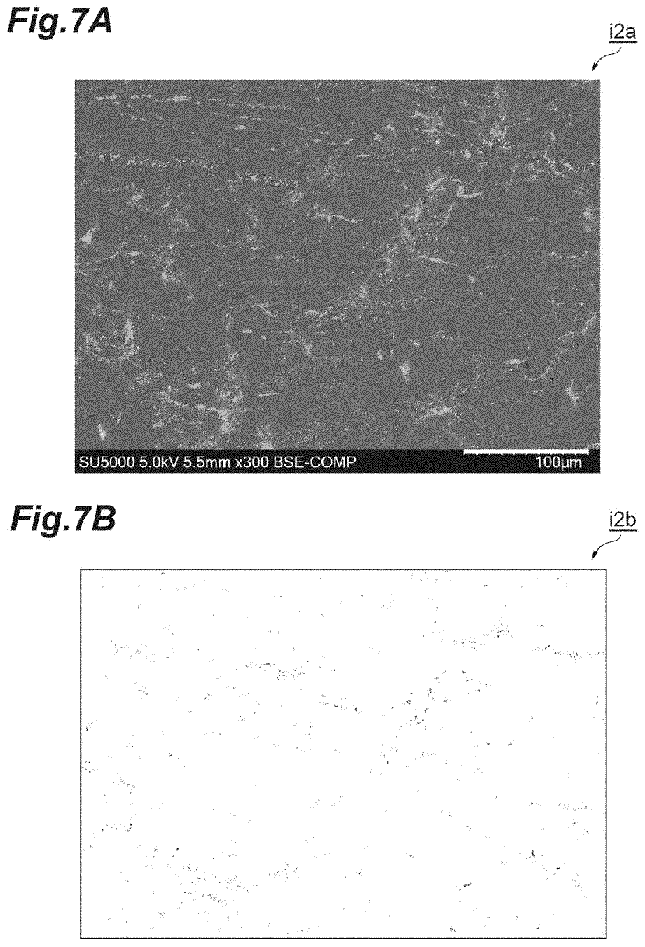

A backscattered electron image i2a of a part of a cross-section of the permanent magnet of Comparative Example 2 is illustrated in FIG. 7A. The cross-section where the backscattered electron image i2a of Comparative Example 2 was taken was parallel to the easy magnetization axis direction. An image i2b in FIG. 7B, an image i2c in FIG. 8A, and an image i2d in FIG. 8B are images obtained from the backscattered electron image i2a of Comparative Example 2.

The monochrome image i2b was obtained by threshold processing of the backscattered electron image i2a of Comparative Example 2.

Each of a plurality of closed curves included in the image i2c corresponds to a contour of each of the voids in the image i2b.

Each dot included in the image i2d represents coordinates (x,y) of a geometric center of each of the voids. A position of each of the voids in the image i2c matches coordinates of each dot in the image i2d.

(Magnetic Characteristics of Permanent Magnet)

The residual magnetic flux density (Br), the coercivity (HcJ), and the squareness ratio (Hk/HcJ) of the permanent magnet of each of Examples 1 to 10 and Comparative Examples 1 and 2 were measured. The residual magnetic flux density, the coercivity, and the squareness ratio were measured by a BH tracer. The coercivity was measured at 23° C. Br was measured at room temperature. The squareness ratio was measured as 23° C. Measured values of the magnetic characteristics of each permanent magnet are shown in the following Table 1.

TABLE 1

| | | | | | | | | | Main phase | | | |
|---|---|---|---|---|---|---|---|---|---|---|---|---|
| | | | | | | | | | grain | Magnetic characteristics | | |
| | | | | Void | | | | | Average | | Residual | |
| | Cooling step | | | | Average | Standard | Correlation | Aspect | value of | | magnetic | |
| | | Pressing | Ram | Area | value | deviation | coefficient | ratio | length of | Coercivity | flux | Squareness |
| | Pressure | time | speed | ratio | of area | of area | of x and y | of void | short axis | [23° C.] | density | ratio |
| | Pc | t | Vc | pr | p_avg | p_std | r | L_{L}/L_{S} | Lc | HcJ | Br | Hk/HcJ |
| | Unit | | | | | | | | | | | |
| | MPa | sec | mm/sec | % | (μm)² | (μm)² | — | — | nm | kA/m | mT | % |
| Example 1 | 50 | 240 | 0.1 | 0.380 | 3.056 | 4.711 | 0.015 | 2.676 | 130 | 1221 | 1385 | 92.5 |
| Example 2 | 40 | 60 | 0.1 | 0.504 | 5.440 | 13.448 | 0.245 | 2.727 | 129 | 1078 | 1322 | 87.6 |
| Example 3 | 20 | 120 | 0.1 | 1.743 | 3.533 | 11.325 | 0.005 | 2.640 | 114 | 1140 | 1290 | 90.9 |
| Comparative | 0 | 0 | 0 | 2.049 | 7.237 | 20.460 | 0.080 | 4.363 | 105 | 980 | 1278 | 85.4 |
| Example 1 | | | | | | | | | | | | |
| Example 4 | 20 | 60 | 0.1 | 1.596 | 5.170 | 12.805 | 0.075 | 2.679 | 112 | 1103 | 1281 | 89.8 |
| Example 5 | 20 | 240 | 0.1 | 1.907 | 2.535 | 3.918 | 0.013 | 2.658 | 118 | 1386 | 1282 | 93.5 |
| Example 6 | 40 | 240 | 0.1 | 0.481 | 1.665 | 2.433 | 0.043 | 2.596 | 128 | 1314 | 1377 | 95.1 |
| Comparative | 60 | 240 | 0.1 | 0.115 | 1.610 | 2.732 | 0.311 | 3.164 | 136 | 964 | 1390 | 94.6 |
| Example 2 | | | | | | | | | | | | |
| Example 7 | 20 | 30 | 0.1 | 1.886 | 10.542 | 3.971 | 0.197 | 2.989 | 110 | 1008 | 1289 | 90.2 |
| Example 8 | 80 | 240 | 1.0 | 0.255 | 12.311 | 7.816 | 0.057 | 1.786 | 147 | 997 | 1380 | 91.9 |
| Example 9 | 20 | 240 | 1.0 | 1.812 | 1.766 | 1.919 | 0.011 | 1.124 | 115 | 1512 | 1285 | 94.9 |
| Example 10 | 20 | 240 | 0.5 | 1.967 | 6.658 | 4.988 | 0.067 | 1.435 | 117 | 1421 | 1287 | 94.2 |

### INDUSTRIAL APPLICABILITY

For example, the R-T-B based permanent magnet according to one aspect of the present invention is appropriate for a material of a motor mounted on an electric vehicle or a hybrid vehicle.

### REFERENCE SIGNS LIST

2: R-T-B based permanent magnet, 2cs: cross-section of permanent magnet, 4: main phase grain, 6: R-rich phase, 8: void, C: easy magnetization axis direction, AB: direction that is approximately orthogonal to easy magnetization axis direction.

What is claimed is:

1. An R-T-B based permanent magnet including a rare-earth element R, a transition metal element T, and B,
wherein the R-T-B based permanent magnet includes at least Nd as the R,
the R-T-B based permanent magnet includes at least Fe as the T,
the R-T-B based permanent magnet contains a plurality of main phase grains and a plurality of voids,
the plurality of main phase grains includes at least the R, the T, and B, and
an area ratio of the plurality of voids in an arbitrary cross-section of the R-T-B based permanent magnet is larger than 0.2% and 2% or smaller.

2. The R-T-B based permanent magnet according to claim 1,
wherein an average value of an area of each of the plurality of voids in the arbitrary cross-section of the R-T-B based permanent magnet is from 0.1 (μm)² to 7 (μm)².

3. The R-T-B based permanent magnet according to claim 1,
wherein a standard deviation of an area of each of the plurality of voids in the arbitrary cross-section of the R-T-B based permanent magnet is from 0 (μm)² to 5 (μm)².

4. The R-T-B based permanent magnet according to claim 1,
wherein the arbitrary cross-section of the R-T-B based permanent magnet has a rectangular shape,
one side among four sides of the rectangular shape is an x-axis,
one side orthogonal to the x-axis among the four sides of the rectangular shape is a y-axis,
an intersection of the x-axis and the y-axis is the origin,
in a coordinate system composed of the origin, the x-axis, and the y-axis, a position of a geometric center of each of the plurality of voids is expressed as (x,y), and
an absolute value of a correlation coefficient r of x and y, which is calculated from the position of the geometric center of each of the plurality of voids, is from 0 to 0.2.

5. The R-T-B based permanent magnet according to claim 1,
wherein in a cross-section of the R-T-B based permanent magnet which is approximately parallel to an easy magnetization axis direction of the R-T-B based permanent magnet, the plurality of main phase grains are flat, and
in the cross-section of the R-T-B based permanent magnet which is approximately parallel to the easy magnetization axis direction of the R-T-B based permanent magnet, an average value of a length of a short axis of the plurality of main phase grains is from 20 nm to 200 nm.

6. The R-T-B based permanent magnet according to claim 1,
wherein a content of the R is from 28 mass % to 33 mass %, and
a content of B is from 0.75 mass % to 1.20 mass %.

7. The R-T-B based permanent magnet according to claim 1,
wherein the plurality of main phase grains are stacked along an easy magnetization axis direction of the R-T-B based permanent magnet.

8. The R-T-B based permanent magnet according to claim 1,
wherein the R-T-B based permanent magnet is a hot deformed magnet.

9. The R-T-B based permanent magnet according to claim 1, further containing a plurality of R-rich phases,
wherein a concentration of the R in the plurality of R-rich phases is higher than a concentration of the R in the plurality of main phase grains, and
a unit of the concentration of the R is atomic %.

10. The R-T-B based permanent magnet according to claim 1.
wherein a long-axis-direction length of each of the plurality of voids observed in the arbitrary cross-section of the R-T-B based permanent magnet is expressed by L_{L},
a short-axis-direction length of each of the plurality of voids observed in the arbitrary cross-section of the R-T-B based permanent magnet is expressed by L_{S},
an aspect ratio of each of the plurality of voids observed in the arbitrary cross-section of the R-T-B based permanent magnet is expressed by L_{L}/L_{S}, and
an average value of L_{L}/L_{S} is from 1 to 2.
